(19) United States
(12) Patent Application Publication
(10) Pub. No.: US 2014/0259336 A1
(43) Pub. Date: Sep. 18, 2014

(54) LIQUID STATUS INDICATOR

(71) Applicant: Aron Schuftan, San Jose, CA (US)

(72) Inventor: Aron Schuftan, San Jose, CA (US)

(21) Appl. No.: 14/211,646

(22) Filed: Mar. 14, 2014

Related U.S. Application Data
(60) Provisional application No. 61/799,821, filed on Mar. 15, 2013.

(51) Int. Cl. C11D 17/00; C11D 3/50; C11D 3/00; C11D 3/48

(52) U.S. Cl. CPC C11D 17/0056; C11D 3/48; C11D 3/50; C11D 3/0036
USPC 4/223; 510/191; 510/109; 424/10.3; 512/1; 252/175; 512/2; 512/4

(57) ABSTRACT

A device may comprise first matter including a first material adapted, when in contact with a liquid, to clean the liquid and to maintain the liquid at a first color. The device may include second matter including a second material adapted, when in contact with the liquid, to maintain the liquid at a second color. The device may further include an interface configured to limit an exposure of the second material to the liquid before at least a portion of the first material contacts the liquid.

### CLAIM OF PRIORITY

This patent application claims priority to and incorporates by reference provisional U.S. Patent No. 61/799,821, entitled “Extended Release Cleaning Tablet,” filed on Mar. 15, 2013.

### TECHNICAL FIELD

The technical field relates to cleaning devices. More particularly, the technical field relates to devices used to clean tanks holding liquids.

### BACKGROUND

It is often desirable to store liquids for various purposes. A flush toilet, for instance, may include a bowl and a tank, each having a standing body of water that is maintained for a flush and that is refilled after the flush.

However, the standing body of water in a liquid storage tank may cause the liquid storage units to become unclean, unsanitary, and/or unsightly. A toilet bowl, for example, may get contaminated with biological and other waste. The toilet bowl may also receive chemicals, garbage, and debris. As another example, a toilet tank may be connected to seemingly fresh water that contains bacteria or other contaminants. Some liquid storage units may even become dirty despite their lack of use. As yet another example, a toilet bowl that has not been used for a while may leave an unsightly ring of mineral deposits and/or residue around the high-water mark of standing water. When pronounced, the resulting stain can undermine confidence in the sanitation and aesthetics of the area containing the toilet.

Cleaning a liquid storage tank conventionally required a bit of labor. For instance, to conventionally remove biological waste from a toilet bowl, a cleaner would apply antibacterial, antiseptic, or other chemicals to the toilet bowl. A cleaner may also use a brush to scrub the surface of the toilet bowl. For debris in a toilet bowl, a cleaner may have to chemically dissolve the debris and scrape portions of the debris that remain after the dissolution. Chemical waste and stains, such as residue rings, may also require the application of cleaning agents and wiping or scraping of loose particles. The labor involved in conventional cleaning techniques may limit the frequency with which a liquid storage tank can be cleaned. It may be desirable to automate cleaning tanks.

### SUMMARY

A liquid status indicator may comprise first matter including a first material adapted, when in contact with a liquid, to clean the liquid and to maintain the liquid at a first color. The liquid status indicator may include second matter including a second material adapted, when in contact with the liquid, to maintain the liquid at a second color. The liquid status indicator may further include an interface configured to limit an exposure of the second material to the liquid before at least a portion of the first material contacts the liquid.

In some embodiments, the interface may comprise one or more of: a portion of the first matter, a portion of the second matter, a portion of third matter distinct from the first matter and the second matter, and a membrane surrounding the second matter. The interface may be configured to couple a second surface of the first matter to a first surface of the second matter.

In various embodiments, the first material may be adapted, when in contact with the liquid, to perform one or more of: sanitizing the liquid, removing bacteria from the liquid, adding a fresh smell to the liquid, and limiting build-up of minerals in the liquid. The first color may be clear. The second color may be one or more of blue, purple, green, or turquoise. The second color may be substantially visually different from the first color.

In certain embodiments, the liquid status indicator may be adapted to clean one or more of a toilet bowl receiving at least a portion of the liquid, and a tank containing the liquid. The liquid status indicator may be placed into a toilet tank containing the liquid. The second material may be adapted, when in contact with the liquid, to clean the liquid. The first matter may be adapted to dissolve after one or more of: a predetermined number of flushes, and a predetermined amount of exposure to the liquid. In particular embodiments, one or more of the first material or the second material comprise one or more of: sodium dodecyl benzene sulfonate, bromochloro-5,5-dimethylhydantoin, calcium chlorate, calcium hydroxide, calcium carbonate, chlorine, and bleach.

The first material may comprise a stabilizer to allow the liquid status indicator to dissolve uniformly. The first material may comprise a first density and the second material may comprise a second density, the first density allowing the first material to dissolve more uniformly than the second material. The first material may a first density and the second material may comprise a second density, the second density being greater than the first density.

In some embodiments, the second material may include one or more of: a powder, a liquid, and a gel. The second material may dissolve soon after contact with liquids. The liquid status indicator may comprise one or more of: a cleaning tablet, and a liquid drip cleaning system.

In various embodiments, the liquid status indicator may comprise a cleaning tablet, and the cleaning tablet is substantially spherical, rectangular, hexagonal, triangular, or cylindrical in shape. The liquid status indicator may comprise a liquid drip cleaning system, and the liquid drip cleaning system comprises a first liquid cleaning layer having the first material, and a second liquid cleaning area having the second material.

A method may comprise: exposing a first material of first matter to contact a liquid; maintaining the liquid at a first color using the first material; exposing an interface to the liquid, the interface coupling at least a portion of the first matter to second matter comprising a second material; and maintaining the liquid at a second color using the second material.

A liquid status indicator may comprise: means for exposing a first material of first matter to contact a liquid; means for maintaining the liquid at a first color; means for exposing an interface to the liquid, the interface coupling at least a portion of the first matter to second matter comprising a second material; and means for maintaining the liquid at a second color.

### BRIEF DESCRIPTION OF THE DRAWINGS

FIG. 1A shows an example of a fluid container environment, according to some embodiments.

FIG. 1B shows an example of a fluid container environment, according to some embodiments.

FIG. 2A shows a cross-sectional top view of a top view of a liquid status indicator, according to some embodiments.

FIG. 2B shows a cross-sectional side view of a side view of a liquid status indicator, according to some embodiments.

FIG. 3 shows a cross-sectional side view of a side view of a liquid status indicator, according to some embodiments.

FIG. 4 shows an example of a method of using a tablet liquid status indicator, according to some embodiments.

FIG. 5 shows an example of a method of using a tablet liquid status indicator, according to some embodiments.

FIG. 6 shows an example of a method of making a tablet liquid status indicator, according to some embodiments.

FIG. 7 shows an example of a method of making a tablet liquid status indicator, according to some embodiments.

FIG. 8 shows an example of a method of making a tablet liquid status indicator, according to some embodiments.

FIG. 9 shows an example of a method of making a tablet liquid status indicator, according to some embodiments.

FIG. 10 shows an example of a tablet liquid status indicator, according to some embodiments.

FIG. 11 shows an example of a tablet liquid status indicator, according to some embodiments.

FIG. 12 shows an example of a tablet liquid status indicator, according to some embodiments.

FIG. 13 shows an example of a tablet liquid status indicator, according to some embodiments.

FIG. 14 shows an example of a tablet liquid status indicator, according to some embodiments.

FIG. 15 shows an example of a tablet liquid status indicator, according to some embodiments.

### DETAILED DESCRIPTION

It may be desirable to automate the cleaning of liquid storage tanks One way to do so is to employ a portable cleaning system, such as a cleaning tablet. For toilets, for instance, a cleaning tablet may include a block of cleaning material that is inserted below the fluid level of a tank. Through contact with tank water, the cleaning material may gradually dissolve and clean the tank. The cleaning materials may also clean the toilet bowl through contact with the flow of water to the bowl. Once the tablet dissolves and its cleaning materials run out, the tablet may have to be changed. Typically, conventional cleaning tablets are either colored or clear. Colored cleaning tablets change the color of water they contact, while clear cleaning tablets do not change the color of water they contact.

Conventional cleaning tablets may present serious problems. Colored cleaning tablets, for instance, may cause the water in a toilet bowl to appear unsightly for an extended period of time. More specifically, were a deep blue cleaning tablet inserted into a toilet tank, the water in the toilet bowl would appear a deep blue for weeks on end, that is, until the cleaning material ran out. Such an appearance may undermine the aesthetics of home bathrooms, or possibly mask serious medical conditions, such as hematuria. Clear cleaning tablets may also present problems. As clear cleaning tablets often fail to change the color of the water of a toilet bowl, clear cleaning tablets may not provide an indicator of when their cleaning materials run out. As a result, a person may have to continually check a toilet tank to see if a clear cleaning tablet has fully dissolved. Conventional cleaning devices do not provide any indicators about the status of liquids being cleaned. The ensuing uncertainty may make it difficult to automate cleaning of toilets. In light of these and other issues, in various embodiments, there is provided a liquid status indicator, that can be used for cleaning and other purposes, as described herein.

FIG. 1A shows an example of a fluid container environment 100a, according to some embodiments. The fluid container environment 100a may include a fluid supply 102, a fluid supply line 104, a tank 106, a tank-bowl line 110, a bowl 112, a waste line 116, and a waste sink 118. In some embodiments, the components of the fluid container environment 100a may correspond to one or more components of a toilet. However, those of ordinary skill in the art will appreciate that the components of the fluid container environment 100a may also correspond to components of other devices that allow for fluid storage units that are to be cleaned.

The fluid supply 102 may be coupled, on one end, a source of clean fluids, and on the other end, to the fluid supply line 104. In some embodiments, the source of clean fluids may comprise a water supply network, such as a municipal water supply network. The fluid supply 102 may provide a source of clean fluids to the fluid supply line 104. The fluid supply 102 may supply clean fluids to components other than the fluid supply line 104. The fluid supply 102 may supply clean fluids to portions of one or more municipalities, communities, neighborhoods, apartment/condominium complexes, buildings, rooms of buildings, etc.

The fluid supply line 104 may be coupled to the fluid supply 102 and the tank 106. The fluid supply line 104 may provide clean fluids from the fluid supply 102 to the tank 106. In some embodiments, the fluid supply line 104 may include a pipe connecting the fluid supply 102 to the tank 106. It is noted that the fluid supply line 104 may incorporate structures other than a pipe. The fluid supply line 104 may be operative to fill the tank 106 to a tank fluid level, as discussed herein.

The tank 106 may be coupled to the fluid supply line 104 and the tank-bowl line 110. The tank 106 may receive clean fluids from the fluid supply 102 through the fluid supply line 104. The tank 106 may also store the clean fluids at a tank fluid level 108. In some embodiments, the tank 106 may incorporate a filling phase and a flushing phase. In the filling phase, the tank 106 may receive clean fluids through the fluid supply line 104 until the fluids in the tank 106 reach the tank fluid level 108. In the flushing phase, the tank 106 may discharge the clean fluids stored within it through the tank-bowl line 110. In various embodiments, the tank 106 may comprise a toilet tank. As such, the filling phase of the tank 106 may correspond to the filling of a toilet, and the flushing phase of the tank 106 may in response to the toilet being flushed. The tank 106 may include a liquid status indicator 120. The liquid status indicator 120 is discussed herein.

The tank-bowl line 110 may be coupled to the tank 106 and the bowl 112. The tank-bowl line 110 may provide clean fluids from the tank 106 to the bowl 112. The tank-bowl line 110 may include a pipe that connects the tank 106 to the bowl 112. It is noted that the tank-bowl line 110 may incorporate structures other than a pipe. The tank-bowl line 110 may be operative to fill the bowl to a bowl fluid level, and to flush the contents of the bowl 112 into the waste sink 118, as discussed herein.

The bowl 112 may be coupled to the tank-bowl line 110 and the waste line 116. The bowl 112 may receive clean fluids from the tank 106 through the tank-bowl line 110. The bowl 112 may store clean fluids at a bowl fluid level 114. In various embodiments, the bowl 112 may also receive waste. The bowl 112 may incorporate a filling phase and a flushing phase. In the filling phase, the bowl 112 may receive clean fluids through the tank-bowl line 110 until the fluids in the bowl 112 reach the bowl fluid level 114. In the flushing phase, the bowl 112 may discharge waste stored within it through the waste line 116. In various embodiments, the bowl 112 may comprise a toilet bowl. The filling phase of the bowl 112 may correspond to the toilet bowl being filled, and the flushing phase may correspond to the toilet bowl being flushed. As the bowl 112 may be exposed to users of the toilet, the bowl 112 may need to be kept in a sanitary state. The liquid status indicator 120, discussed herein, may be operative to clean the water in the bowl 112.

The waste line 116 may be coupled to the bowl 112 and the waste sink 118. The waste line 116 may provide waste from the bowl 112 to the waste sink 118. The waste line 116 may comprise a pipe that connects the bowl 112 to the waste sink 118. The waste line 116 may also incorporate structures other than a pipe. The waste sink 118 may be coupled, on one end, to the waste line 116, and on the other end, to a sewer or septic tank.

The liquid status indicator 120 may be inserted into the tank 106. In the example of FIG. 1A, the liquid status indicator 120 may reside below the tank fluid level 108. The liquid status indicator 120 may clean the tank water in the tank 106 and the bowl water in the bowl 112. As such, the liquid status indicator 120 may incorporate cleaning materials that clean the tank 106 and the bowl 112. For instance, the liquid status indicator 120 may, in various embodiments, remove bacteria from the tank, add a fresh smell to the tank, limit build-up of minerals in the tank, and limit build-up of debris in the tank.

In some embodiments, the liquid status indicator 120 may maintain the color of water in the tank 106 and/or the bowl 112 at a first color for a period of time. After that period of time, the liquid status indicator 120 may maintain the color of water in the tank 106 and/or bowl 112 at a second color. The second color may be different from the first color. In various embodiments, the first color or the second color may be blue, violet, green, orange, yellow, red, black, or any other color. The first color or the second color may also be “clear;” that is, the natural color of the water. More specifically, in some embodiments, one or more of the first color and the second color need not color the water at all, but rather, may maintain the water at the natural color of the water without waste inside.

In some embodiments, the liquid status indicator 120 may provide users with an indicator of when the cleaning materials in the liquid status indicator 120 have run out or are about to run out. That is, in some embodiments, the liquid status indicator 120 may maintain the water in the tank 106 and/or the bowl 112 at a clear color for a specified amount of time. Once the cleaning materials in the liquid status indicator 120 have run out or are about to run out, the liquid status indicator 120 may maintain the water in the tank 106 and/or the bowl 112 at a second color, such as blue. Once a person seeking to replace the liquid status indicator 120 has seen that the water in the bowl 112 is of the second color (e.g., blue), the person knows that it is time to replace the liquid status indicator 120, as the cleaning materials within have run out or are about to run out. In some embodiments, embedded in the liquid status indicator 120 is an intelligent timer that tells users when it is time for a replacement. This presents at least several advantages. More specifically, users need not constantly look into the tank 106 to see if the liquid status indicator 120 is finished dissolving, as the user would have to with clear tablets. Moreover, users of the liquid status indicator 120 need not have a colored toilet tank, as users would have to with a purely colored tablet.

Although FIG. 1A shows the liquid status indicator 120 as residing within the tank 106, it is noted that the liquid status indicator 120 may be located elsewhere within the fluid container environment 100a and may still clean the bowl liquid in the bowl 112 and/or the tank liquid in the tank 106 without departing from the inventive concepts described herein. For example, the liquid status indicator 120 may be placed anywhere in the path of liquids to the bowl 112. It is also noted that the liquid status indicator 120 may be placed within one or more of the fluid supply 102, the fluid supply line 104, the tank-bowl line 110, and the bowl 112. Such configurations may still be capable of cleaning the bowl 112.

The liquid status indicator 120 may be implemented as one or more physical layouts. In some embodiments, the liquid status indicator 120 may be implemented as a cleaning tablet. The cleaning tablet may include a gel, a liquid, or a powder, in various embodiments. FIG. 2A and FIG. 2B further show a tablet liquid status indicator. In various embodiments, the liquid status indicator 120 may also be implemented as a drip cleaning system that drips materials into the tank 106. The drip cleaning system may include a gel, a liquid, or a powder. FIG. 3 further shows a drip liquid status indicator. In some embodiments, the liquid status indicator 120 may include portions of a cleaning tablet as well as portions of a drop cleaning system, as discussed herein.

FIG. 1B shows an example of a fluid container environment 100b, according to some embodiments. The fluid container environment 100b includes a tank 122. The tank may be adapted to hold a fluid 124, which in turn may have a tank fluid level 126. In various embodiments, the tank 122 may include one or more of a portion of: a toilet, a swimming pool, a bathtub, a sink, a well, a gasoline tank, a beaker, etc. The fluid 124 may include a liquid status indicator 120, as described further herein.

FIG. 2A shows a cross-sectional top view of a tablet liquid status indicator 200, according to some embodiments. The tablet liquid status indicator 200 may correspond to the liquid status indicator 120, shown in FIGS. 1A and/or 1B. In various embodiments, the tablet liquid status indicator 200 may maintain the color of liquid that it is in contact with at a first color for a period of time. The tablet liquid status indicator 200 may also maintain the color of liquid that it is in contact with at a second color after that period of time. The tablet liquid status indicator 200 may have a variety of shapes, including, without limitation, a sphere, a rectangular shape, a hexagonal shape, a cylindrical shape, or other shape. In some embodiments, the tablet liquid status indicator 200 may have a diameter of approximately three inches. The tablet liquid status indicator 200 may include first matter 202 and second matter 204 embedded inside the first matter 202. As an embedded area, the second matter 204 need not be exposed to liquid until the first matter 202 dissolves to expose the second matter 204. That is, the second matter 204 may be completely insulated from liquids until at least a portion of the first matter 202 dissolves.

The first matter 202 may include a first outer surface 206 and a first inner surface 208, and be made of a first material 210. In some embodiments, the first matter 202 may comprise a first capsule. The first outer surface 206 of the first matter 202 may correspond to the outer surface of the tablet liquid status indicator 200. The first outer surface 206 may designate the outer boundary of the first material 210. In some embodiments, the first outer surface 206 may have a first diameter 212. The first diameter 212 may vary depending on the intended use of the tablet liquid status indicator 200, and/or the duration the tablet liquid status indicator 200 is expected to last. The first diameter may be chosen so that, after a specified number of flushes, the second matter 204 is exposed to tank liquids. In various embodiments, the first diameter 212 may comprise approximately three inches.

The first inner surface 208 of the first matter 202 may designate the inner boundary of the first material 210. The first inner surface 208 may have a second diameter 214. The second diameter 214 may also vary depending on the intended use of the tablet liquid status indicator 200, and/or the duration the tablet liquid status indicator 200 is expected to last. However, in various embodiments, the first diameter 212 may comprise a distance that is chosen to render the second matter 204 relatively small in comparison to the first matter 202. By choosing the second diameter 214 to be small relative to the first diameter 212, it can be assured that the second matter 204 may contact liquids (and color the bowl 112) very soon before the tablet liquid status indicator 200 is about to dissolve. In some embodiments, the second diameter 214 may be approximately one-half of an inch.

The first material 210 may dissolve it touches liquids. The dissolution may begin at the first outer surface 206 and continue inwardly to the first inner surface 208. In some embodiments, the first material 210 may include cleaning materials that are capable of cleaning the tank 106 and/or the bowl 112. The cleaning materials may comprise one or more of: sodium dodecyl benzene sulfonate, bromochloro-5,5-dimethylhydantoin, calcium chlorate, calcium hydroxide, calcium carbonate, chlorine, and bleach. It is noted that the first material 210 may comprise other cleaning materials as well. In various embodiments, the first material 210 may comprise one or more of a gel, a liquid, and a powder.

The first material 210 may comprise a first colored material that, when in contact with liquids, causes the liquids to be maintained at a first color. In some embodiments, the first colored material may render liquids that are in contact to maintain the color the liquids (i.e., the first color may be clear). In various embodiments, the first color may include a light or pastel color. The first color may also comprise other colors without departing from the scope and substance of the inventive concepts described herein. It is noted that some colors may be preferable. For instance, it may not be preferable to choose the first color as yellow or brown for toilet cleaning applications.

The second matter 204 may include a second outer surface 216, a center point (e.g., the center point of the second matter 204 in FIG. 2A), and be made of a second material 218. In some embodiments, the second matter 204 may comprise a second capsule. The second outer surface 216 of the second matter 204 may correspond to the first inner surface 208 of the first matter 202.

The second outer surface 216 may be coupled to the first inner surface 208 through an interface that holds the first material 210 to the second material 218. The interface may also, in some embodiments, keep the second material 218 from being exposed to the liquid before at least a portion of the first material 210 has fully dissolved. More specifically, in some embodiments, the interface may comprise a portion of the first matter 202. That is, the interface may include an area of the first matter 202 that corresponds to or further includes the first inner surface 208 of the first matter 202. In various embodiments, the interface may comprise a portion of the second matter 204, such as an area of the second matter 204 that corresponds to or further includes the second outer surface 216 of the second matter 204. In certain embodiments, the interface may include third matter that is distinct from the first matter 202 and/or the second matter 204. The interface may also include, in some embodiments, a structure such as a membrane that surrounds the second matter 204.

In the example of FIG. 2A, the second outer surface 216 may have the second diameter 214. As discussed, the second diameter 214 may vary, but in various embodiments, may be chosen relatively small compared to the first diameter 212. In some embodiments, the second diameter 214 may comprise one-half of an inch.

The second material 218 may dissolve as it touches liquids. The dissolution may begin at the second outer surface 216 and continue inwardly to the center point. The second material 218 may include materials that are capable of cleaning the tank 106 and/or the bowl 112. The cleaning materials may or may not correspond to the cleaning materials in the first material 210. The cleaning materials in the second material 218 may, in some embodiments, comprise one or more of: sodium dodecyl benzene sulfonate, bromochloro-5,5-dimethylhydantoin, calcium chlorate, calcium hydroxide, calcium carbonate, chlorine, and bleach. It is noted that the second material 218 may comprise other cleaning materials as well. In various embodiments, the second material 218 may comprise one or more of a gel, a liquid, and a powder.

The second material 218 may comprise a second colored material that, which in contact with liquids, causes the liquids to be maintained at a second color. In various embodiments, the second color may be distinct from the first color (i.e., the color maintained by the first material 210). In some embodiments, the second color of the second material 218 may comprise a color that is chosen to create a contrast with the first color. For example, were the first color chosen to maintain liquids clear, the second color may be chosen to maintain the liquids a deep color (e.g., deep blue). As another example, were the first color chosen to maintain the liquids a pastel color, the second color may be chosen to maintain the liquids at a dark color.

In various embodiments, the second material 218 may include a liquid or a gel that dissolves soon after contact with liquids. In these embodiments, the first material 210 may nonetheless comprise a solid tablet. As such, the water in the tank 106 may become colored immediately upon contact with the liquids that are being cleaned.

In some embodiments, to prevent uneven breaking of the tablet liquid status indicator 200, the first matter 202 and/or the second matter 204 may include stabilizers to ensure that the tablet liquid status indicator 200 dissolves evenly. Such stabilizers may ensure that the first matter 202 dissolves uniformly and that the second matter 204 is exposed to liquids only after complete dissolution of the first matter 202. In various embodiments, the first material 210 may include density gradients such that, as the first material 210 dissolves, the first material 210 may become less dense and the first material 210 may dissolve more easily. The second material 218 may also include similar or different density gradients.

FIG. 2B shows a cross-sectional side view of a tablet liquid status indicator 200, according to some embodiments. The elements of the tablet liquid status indicator 200 shown in FIG. 2B may correspond to the elements of the tablet liquid status indicator 200 shown in FIG. 2A. Additionally, in FIG. 2B, there is shown a first height 220 and a second height 222. The first height 220 may correspond to the height of the first matter 202. The second height 222 may correspond to the height of the second matter 204.

FIG. 3 shows a cross-sectional side view of a side view of a drip liquid status indicator 300, according to some embodiments. The drip liquid status indicator 300 may correspond to the liquid status indicator 120, shown in FIGS. 1A and/or 1B. In various embodiments, the drip liquid status indicator 300 may maintain the color of liquid that it is in contact with at a first color for a period of time. The drip liquid status indicator 300 may also maintain the color of liquid that it is in contact with at a second color after that period of time. The drip liquid status indicator 300 may include a first matter 302, a second matter 304, a spout 306, and an outer surface 308. In some embodiments, the second matter 304 need not be exposed to liquid until the first matter 302 has left the spout 306. That is, the second matter 304 may be completely insulated from liquids until at least a portion of the first matter 302 has left the spout 306.

The first matter 302 may include a first surface 310 and a second surface 312, and may be made of a first material 314. The first surface 310 may correspond to the bottom surface of the first matter 302. For instance, the first surface 310 may align with at least a portion of the bottom of the outer surface 308. In some embodiments, the first surface 310 may designate a lower boundary of the first material 314. The second surface 312 may correspond to an upper surface of the first matter 302 and/or a lower surface (e.g., the first surface 316) of the second matter 304. An interface between the second surface 312 and the first surface 316 may separate the first matter 302 and the second matter 304. For example, the second surface 312 may designate an upper boundary of the first material 314.

The first material 314 may dissolve into a liquid when the first material 314 touches the liquid. In some embodiments, the first material 314 may exit the drip liquid status indicator 300 through the spout 306. In various embodiments, the first material 314 may contain cleaning materials that are capable of the cleaning the tank 106 and/or the bowl 112. The cleaning materials may comprise one or more of: sodium dodecyl benzene sulfonate, bromochloro-5,5-dimethylhydantoin, calcium chlorate, calcium hydroxide, calcium carbonate, chlorine, and bleach. It is noted that the first material 314 may comprise other cleaning materials as well. In various embodiments, the first material 314 may comprise one or more of a gel, a liquid, and a powder.

The first material 314 may comprise a first colored material that, when in contact with liquids, causes the liquids to be maintained at a first color. In some embodiments, the first colored material may render liquids that are in contact to maintain the color the liquids (i.e., the first color may be clear). In various embodiments, the first color may include a light or pastel color. The first color may also comprise other colors without departing from the scope and substance of the inventive concepts described herein. It is noted that some colors may be preferable. For instance, it may not be preferable to choose the first color as yellow or brown for toilet cleaning applications.

The second matter 304 may include a first surface 316 and may be made of a second material 318. The first surface 316 may align with at least a portion of an upper surface (e.g., the second surface 312) of the first matter 302. In some embodiments, the first surface 316 may designate a lower boundary of the second material 318. The second material 318 may dissolve into a liquid when the second material 318 touches the liquid.

In some embodiments, the second material 318 may exit the drip liquid status indicator 300 through the spout 306. In various embodiments, the second material 318 may contain cleaning materials that are capable of the cleaning the tank 106 and/or the bowl 112. The cleaning materials may comprise one or more of: sodium dodecyl benzene sulfonate, bromochloro-5,5-dimethylhydantoin, calcium chlorate, calcium hydroxide, calcium carbonate, chlorine, and bleach. It is noted that the second material 318 may comprise other cleaning materials as well. In various embodiments, the second material 318 may comprise one or more of a gel, a liquid, and a powder. In some embodiments, the ratio of the first material 314 to the second material 318 may be chosen so that after a specified number of flushes, the second matter 304 is exposed to tank liquids.

The second material 318 may comprise a second colored material that, which in contact with liquids, causes the liquids to be maintained at a second color. In various embodiments, the second color may be distinct from the first color (i.e., the color maintained by the first material 314). In some embodiments, the second color of the second material 318 may comprise a color that is chosen to create a contrast with the first color. For example, were the first color chosen to maintain liquids clear, the second color may be chosen to maintain the liquids a deep color (e.g., deep blue). As another example, were the first color chosen to maintain the liquids a pastel color, the second color may be chosen to maintain the liquids at a dark color.

In various embodiments, the second material 318 may include a liquid or a gel that dissolves soon after contact with liquids. In these embodiments, the first material 314 may nonetheless comprise a solid tablet. As such, the water in the tank 106 may become colored immediately upon contact with the liquids that are being cleaned.

The spout 306 may include any structure to allow the first material 314 and the second material 318 to enter the liquid. In some embodiments, the spout 306 may allow the first material 314 and the second material 318 to drip into the liquid. Though FIG. 3 shows a “spout,” it is noted various embodiments can conceivably include any structure that allows at least a portion of the first material 314 and/or the second material 318 to contact the liquid. The outer surface 308 may provide an outer boundary of the drip liquid status indicator 300. In various embodiments, the outer surface 308 may prevent the first matter 302 and/or the second matter 304 from contacting the liquid.

FIG. 4 shows an example of a method 400 of using a liquid status indicator, according to some embodiments. The method 400 is discussed in conjunction with the fluid container environment 100 shown in FIGS. 1A and/or 1B, and the tablet liquid status indicator 200, shown in FIG. 2A and FIG. 2B. The method 400 is also discussed in conjunction with the drip liquid status indicator 300, shown in FIG. 3.

At module 402, first material of first matter is exposed to liquid. In some embodiments, the first material 210 of the first matter 202 is exposed to the liquid in the tank 106. In various embodiments, the first material 314 of the first matter 302 is exposed to the liquid in the tank 106. In some embodiments, the liquid status indicator 120 may have been placed into the tank 106. A user may have placed the liquid status indicator 120 below the tank fluid level 108. The exposure of the first material 210 and/or the first material 314 to the liquid may have occurred through a filling phase of the tank 106 or a flushing phase of the tank 106. In various embodiments, the first material 210 and/or first material 314 may be exposed to the flow of water from the tank 106 to the bowl 112.

At module 404, a portion of the first material is dissolved from a first surface of the first matter to a second surface of the first matter. In some embodiments, the first material 210 is dissolved inwardly from the first outer surface 206 to the first inner surface 208. As the first material 210 contacts liquids in the tank 106, the first material 210 may clean the liquids in the tank 106 and the bowl 112. As the contact continues, portions of the first material 210 may dissolve into the liquids in the tank 106. A cleaned mixture, including the dissolved portions of the first material 210, may flow into the bowl 112. In various embodiments, the first material 314 may be dissolved from the first surface 310 to the second surface 312.

At module 406, the bowl liquid is maintained at a first color with the first material. In some embodiments, the color of the liquid in the bowl 112 may be maintained at a first color with the first material 210 and/or the first material 314. The colored material in the first material 210 and/or the first material 314 may, upon contact with the liquid in the tank 106, maintain the liquid of the bowl 112 at the first color. As discussed, in various embodiments, the first color may be clear, and in other embodiments, may be a pastel color. The first color may be chosen to facilitate efficient toilet cleaning

At module 408, a portion of an interface coupling the first surface of the first matter to a first surface of the second matter is exposed to the tank liquid. In some embodiments, the interface coupling the first inner surface 208 to the second outer surface 216 of the second matter 204 may be exposed to the liquid in the tank 106. More specifically, the first material 210 may have been dissolved to expose the interface between the first inner surface 208 and the second outer surface 216. That interface may in turn be exposed to the liquids in the tank 106. In various embodiments, the interface between the second surface 312 and the first surface 316 may be exposed to the liquid in the tank 106.

At module 410, a portion of the interface is dissolved to expose second material included in the second matter. In some embodiments, the interface may be dissolved to expose the second material 218 in the second matter 204. Further, in various embodiments, the interface may be dissolved to expose the second material 318 in the second matter 304. Once the second material 218 and/or the second material 318 is exposed to the liquid in the tank 106, the second material 218 and/or the second material 318 may begin sanitizing and coloring the liquids in the tank 106 and/or the bowl 112.

At module 412, at least a portion of the second material is dissolved into the tank liquid. In some embodiments, the second material 218 may be dissolved inwardly from the second outer surface 216. In various embodiments, the second material 318 may be dissolved from the first surface 316 on. As the second material 218 and/or second material 318 contacts liquids in the tank 106, the second material 218 and/or second material 318 may clean the liquids in the tank 106 and the bowl 112. As the contact continues, portions of the second material 218 and/or second material 318 may dissolve into the liquids in the tank 106. A cleaned mixture, including the dissolved portions of the second material 218 and/or the second material 318, may flow into the bowl 112.

At module 414, the bowl liquid is maintained at a second color with the second material. In various embodiments, the second material 218 and/or second material 318 may be used to maintain the liquid in the bowl 112 at a second color. The colored material in the second material 218 and/or second material 318 may, upon contact with the liquid in the tank 106, maintain the liquid at the second color. The second color may be chosen to maintain the liquid in the bowl 112 at a deep color, or to create a contrast with the first color.

FIG. 5 shows an example of a method 500 of using a tablet liquid status indicator, in accordance with some embodiments. The method 500 is discussed in conjunction with the fluid container environment 100 shown in FIGS. 1A and/or 1B and the tablet liquid status indicator 200, shown in FIG. 2A and FIG. 2B.

At module 502, the tablet liquid status indicator 200 may be obtained. At module 504, the tablet liquid status indicator 200 may be placed into the tank 106. At module 506, a number of toilet flushes may be executed until the first matter 202 dissolves. At module 508, a portion of the second matter 204 may be dissolved. At module 510, a portion of the bowl 112 may be colored due to the dissolution of the portion of the second matter 204. At module 512, the tablet liquid status indicator 200 may be changed.

FIG. 6 shows an example of a method 600 of making a tablet liquid status indicator, according to some embodiments. The method 600 is discussed in conjunction with the tablet liquid status indicator 200, shown in FIG. 2A and FIG. 2B.

At module 602, a first piece of the first material may be provided. The first material may be adapted, when in contact with a liquid, to dissolve, to clean the liquid, and to maintain the liquid at a first color. The first piece may be shaped as a tablet. The first piece may have the first diameter 212. The first piece may also have the first height 220.

At module 604, a second piece of the second material may be provided. The second material may be adapted, when in contact with the liquid, to dissolve and maintain the liquid at a second color. The second material may or may not clean the liquid. The second piece may have the second diameter 214. The second piece may have the second height 222.

At module 606, a hollow area is created in the first piece. The hollow area may be sized to accommodate the second piece. As such, the hollow area may be sized to have the second diameter 214 and the second height 222. The hollow area may also be shaped to accommodate the second piece. To create the hollow area, a third piece (e.g., the top surface) of the first material may be removed from the first piece. The hollow area may then be carved out from the portion remaining of the first piece.

At module 608, the second piece may be inserted into the hollow area. At module 610, the second piece may be sealed with the third piece of the first material. Such sealing may insulate the second piece of the second material from exposure to external liquids until the first piece of the first material dissolves to expose the second piece. The resulting tablet liquid status indicator 200 may be provided.

FIG. 7 shows an example of a method 700 of making a tablet liquid status indicator, according to some embodiments. The method 700 is discussed in conjunction with the tablet liquid status indicator 200, shown in FIG. 2A and FIG. 2B. At module 702, a clear tablet is fabricated. The clear tablet may have the first diameter 212 and the first height 220. The clear cleaning tablet may be made of the first material 210. At module 704, a first surface of the clear tablet may be removed. At module 706, at least a portion of the interior of the clear tablet is removed to create a depression. The depression may have the second diameter 214 and the second height 222. At module 708, colored tablet material may be placed into a portion of the depression. The colored material may be made of the second material 218. At module 710, the colored portion may be covered with clear cleaning tablet material. More specifically, portions of the first material 210 may be used to cover the colored portion. In some embodiments, covering the colored portion with clear cleaning tablet material may cause the colored portion to become embedded inside the clear material. At module 712, the resulting tablet liquid status indicator 200 may be sealed. Advantageously, after the clear portions dissolve, the embedded colored portions may color liquids with which they contact.

FIG. 8 shows an example of a method 800 of making a tablet liquid status indicator, according to some embodiments. The method 800 is discussed in conjunction with the tablet liquid status indicator 200, shown in FIG. 2A and FIG. 2B.

At module 802, a central portion of the second matter 204 may be fabricated. The central portion includes the second material 218 that is adapted, when in contact with liquid, to dissolve into the liquid and to maintain the liquid at a second color. In various embodiments, fabricating the central portion of the second matter 204 may include heating the second material 218 to a liquid and placing drops of the liquid into a second mold. The second mold may have the second diameter 214 and the second height 222.

At module 804, the second outer surface 216 may be fabricated. The second outer surface 216 may include the second material 218. The second outer surface 216 may also surround the center portion of the second matter 204. In some embodiments, fabricating the second outer surface 216 may include heating the second material 218 to a liquid and filling out the second mold with the liquid. The resulting product may be cooled to create the second matter 204.

At module 806, the first inner surface 208 of the first matter 202 may be fabricated. The first inner surface 208 may surround the second outer surface 216. The first inner surface 208 may include the first material 210. The first material 210 may be adapted, when in contact with liquid, to dissolve into the liquid, to clean the liquid, and to maintain the color of the liquid at the first color. Fabricating the first inner surface 208 may include removing the second matter 204 from the second mold, and placing the second matter 204 into a first mold. The first mold may have the first diameter 212 and the first height 220. After the second matter 204 is placed in the first mold, the second material 218 may be heated to a liquid and poured around the second matter 204.

At module 808, the first outer surface 206 of the first matter 202 may be fabricated. The first outer surface 206 may include the first material 210 and may surround the first inner surface 208. In some embodiments, fabricating the first outer surface 206 may include heating the first material 210 to a liquid and filling out the first mold with the liquid. The resulting product may be cooled to produce the tablet liquid status indicator 200.

FIG. 9 shows an example of a method 900 of making a tablet liquid status indicator, according to some embodiments. The method 900 is discussed in conjunction with the tablet liquid status indicator 200, shown in FIG. 2A and FIG. 2B. At module 902, the second matter 204 of the tablet liquid status indicator 200 is fabricated. The second matter 204 may be fabricated out of the second material 218. At module 904, the first matter 202 of the tablet liquid status indicator 200 is fabricated around the second matter 204 out of the first material 210 to create the tablet liquid status indicator 200. At module 906, stabilizers may be added to the tablet liquid status indicator 200. At module 908, sealant may be added to the tablet liquid status indicator 200. At module 910, the tablet liquid status indicator 200 may be treated.

FIG. 10 shows an example 1000 of a first piece of first material. In the example of FIG. 10, the first piece of first material includes clear cleaning material that cleans liquids upon contact and does not change the color of the liquids, i.e., it keeps the liquids clear. The central area of the first piece has been removed to create a hollow area. The first piece has also been sliced to create two thinner pieces that can later sandwich a second piece of the second material.

FIG. 11 shows an example 1100 of a second piece of second material inserted into the first piece of cleaning material. The second piece of the second material includes cleaning material that cleans liquids and makes the liquids blue upon contact. The second piece has been sized to be inserted into the hollow area of the first piece.

FIG. 12 shows an example 1200 of a partially assembled tablet liquid status indicator. An interface has been created to link the second outer surface of the second piece to the first inner surface of the first piece. Sealant has been applied over the interface.

FIG. 13 shows an example 1300 a partially assembled tablet liquid status indicator. After sealant was applied, the partially assembled tablet liquid status indicator has been allowed to sit to allow the sealant to dry.

FIG. 14 shows an example 1400 of a set of tablet liquid status indicators. In the set of tablet liquid status indicators, the slices of the first material have been used to sandwich the second piece of the second material. The second piece of the second material is insulated from exposure to liquids until the first piece of the first material has dissolved.

In some embodiments, a cleaning system may include first matter including a first material, the first material adapted, when in contact with a tank liquid, to clean a portion of a bowl coupled to the tank and to maintain bowl liquid of the bowl at a first color. Second matter that includes second material adapted, when in contact with the tank liquid, to maintain the bowl liquid in the bowl at a second color may be included. The cleaning system may also include an interface configured to couple the first matter to the second matter, and configured to limit an exposure of the second material to the tank liquid before at least a portion of the first material contacts the tank liquid.

In some embodiments, the first material may be adapted, when in contact with the tank liquid, to dissolve inwardly from a first surface of the first matter to a second surface of the first matter. The second material may be adapted, when in contact with the tank liquid to dissolve inwardly from a first surface of the second matter. The interface may be configured to couple a second surface of the first matter to a first surface of the second matter.

In various embodiments, cleaning the portion of the tank may comprise one or more of: sanitizing the bowl, removing bacteria from the bowl, adding a fresh smell to the bowl, limiting build-up of minerals in the bowl, and limiting build-up of debris in the bowl. The first color may be clear. The second color may be one or more of blue, purple, green, or turquoise. Further, in some embodiments, the second color may be substantially different from the first color.

In various embodiments, the cleaning system may be adapted to clean a toilet bowl operatively coupled to the tank liquid. The cleaning system may be placed into a toilet tank containing the tank liquid. The tank liquid may be in a flow of a liquid to the bowl. The second material may be adapted, when in contact with the tank liquid, to clean the tank liquid, thereby cleaning the bowl.

In some embodiments, the first matter may be adapted to dissolve after a predetermined number of flushes or after a predetermined amount of exposure to the tank liquid. One or more of the first material and the second material may comprise one or more of: sodium dodecyl benzene sulfonate, bromochloro-5,5-dimethylhydantoin, calcium chlorate, calcium hydroxide, calcium carbonate, chlorine, and bleach. In some embodiments, the first material may comprise a stabilizer to allow the cleaning system to dissolve uniformly. The second material may include a liquid or a gel that dissolves soon after contact with liquids. The first material may include a solid cleaning material.

In various embodiments, the cleaning system may comprise a cleaning tablet. The cleaning tablet may be substantially spherical, rectangular, hexagonal, triangular, or cylindrical in shape.

In some embodiments, the cleaning system may comprise a liquid drip cleaning system. The liquid drip cleaning system may comprise a first liquid cleaning layer having the first material, and a second liquid cleaning area comprising the second material. One or more of the first matter and the second matter may comprise an enclosed area.

A method may comprise: exposing a first material of first matter to contact a tank liquid; dissolving the first material inwardly from a first outer surface of the first matter to a first inner surface of the first matter; maintaining bowl liquid of a bowl coupled to the tank at a first color with the first material; exposing an interface to the tank liquid, the interface coupling the first surface of the first matter to an first surface of second matter; dissolving the interface to expose a second material included in the second matter; dissolving at least a portion of the second material into the tank liquid; and maintaining the bowl liquid at a second color with the second material.

In some embodiments, the method may comprise cleaning the tank liquid with the first material. The method may comprise cleaning the tank liquid with the second material. In some embodiments, the first color may be clear, and the second color may be one or more of blue, purple, green, or turquoise.

A method may comprise: providing a first piece of a first material, the first material adapted, when in contact with a liquid, to dissolve, to clean the liquid, and to maintain the liquid at a first color; providing a second piece of a second material, the second material adapted, when in contact with the liquid, to dissolve, to maintain the liquid at a second color; creating a depression in the first piece; inserting the second piece into the depression; and sealing the second piece with a third piece of the first material, thereby insulating the second piece from exposure to external liquids. In various embodiments, the depression may comprise a hollow area.

A method may include: fabricating a central portion of a second matter, the second matter including a second material that may be adapted, in contact with a liquid, to dissolve inwardly from a second outer surface to a center portion, and to maintain the liquid at a second color; fabricating the second outer surface of the second matter, the second outer surface including the second material, and the second outer surface surrounding the center portion of the second matter; fabricating a first inner surface of first matter, the first inner surface surrounding the second outer surface, and the first inner surface including a first material that may be adapted, when in contact with the liquid, to dissolve inwardly from a first outer surface to the first inner surface, to clean the liquid, and to maintain the color of the liquid at a first color; and fabricating the first outer surface of the first matter, the first outer surface including the first material, and the first outer surface surrounding the first inner surface.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the following claims.

The figures depict various embodiments of the present invention for purposes of illustration only, wherein the figures use like reference numerals to identify like elements. It is noted that the figures are not to scale unless the figures otherwise specify. One skilled in the art will readily recognize from the following discussion that alternative embodiments of the structures and methods illustrated in the figures may be employed without departing from the principles described herein.

What is claimed is:

1. A liquid status indicator comprising:
first matter including a first material adapted, when in contact with a liquid, to clean the liquid and to maintain the liquid at a first color;
second matter including a second material adapted, when in contact with the liquid, to maintain the liquid at a second color; and
an interface configured to limit an exposure of the second material to the liquid while at least a portion of the first material contacts the liquid.

2. The liquid status indicator of claim 1, wherein the interface comprises one or more of: a portion of the first matter, a portion of the second matter, a portion of third matter distinct from the first matter and the second matter, and a membrane surrounding the second matter.

3. The liquid status indicator of claim 1, wherein the interface is configured to couple a second surface of the first matter to a first surface of the second matter.

4. The liquid status indicator of claim 1, wherein the first material is adapted, when in contact with the liquid, to perform one or more of: sanitizing the liquid, removing bacteria from the liquid, adding a fresh smell to the liquid, and limiting build-up of minerals in the liquid.

5. The liquid status indicator of claim 1, wherein the first color is clear.

6. The liquid status indicator of claim 5, wherein the second color is one or more of blue, purple, green, or turquoise.

7. The liquid status indicator of claim 1, wherein the second color is substantially visually different from the first color.

8. The liquid status indicator of claim 1, wherein the liquid status indicator is adapted to clean one or more of a toilet bowl receiving at least a portion of the liquid, and a tank containing the liquid.

9. The liquid status indicator of claim 1, wherein the liquid status indicator is placed into a toilet tank containing the liquid.

10. The liquid status indicator of claim 1, wherein the second material is adapted, when in contact with the liquid, to clean the liquid.

11. The liquid status indicator of claim 1, wherein the first matter is adapted to dissolve after one or more of: a predetermined number of flushes, and a predetermined amount of exposure to the liquid.

12. The liquid status indicator of claim 1, wherein one or more of the first material or the second material comprise one or more of: sodium dodecyl benzene sulfonate, bromochloro-5,5-dimethylhydantoin, calcium chlorate, calcium hydroxide, calcium carbonate, chlorine, and bleach.

13. The liquid status indicator of claim 1, wherein the first material comprises a stabilizer to allow the liquid status indicator to dissolve uniformly.

14. The liquid status indicator of claim 1, wherein the first material comprises a first density and the second material comprises a second density, the first density allowing the first material to dissolve more uniformly than the second material.

15. The liquid status indicator of claim 1, wherein the first material comprises a first density and the second material comprises a second density, the second density being greater than the first density.

16. The liquid status indicator of claim 1, wherein the second material includes one or more of: a powder, a liquid, and a gel

17. The liquid status indicator of claim 1, wherein the second material dissolves soon after contact with liquids.

18. The liquid status indicator of claim 1, wherein the liquid status indicator comprises one or more of: a cleaning tablet, and a liquid drip cleaning system.

19. The liquid status indicator of claim 1, wherein the liquid status indicator comprises a tablet liquid status indicator, and the cleaning tablet is substantially spherical, rectangular, hexagonal, triangular, or cylindrical in shape.

20. The liquid status indicator of claim 1, wherein the liquid status indicator comprises a drip liquid status indicator, and the drip liquid status indicator comprises a first liquid cleaning layer having the first material, and a second liquid cleaning area having the second material.

21. A method comprising:
exposing a first material of first matter to contact a liquid;
maintaining the liquid at a first color using the first material;
exposing an interface to the liquid, the interface coupling at least a portion of the first matter to second matter comprising a second material; and
maintaining the liquid at a second color using the second material.

22. A liquid status indicator comprising:
means for exposing a first material of first matter to contact a liquid;
means for maintaining the liquid at a first color;
means for exposing an interface to the liquid, the interface coupling at least a portion of the first matter to second matter comprising a second material; and
means for maintaining the liquid at a second color.
